(19) United States
(12) Patent Application Publication
(10) Pub. No.: US 2026/0318429 A1
(43) Pub. Date: Oct. 15, 2026

(54) MULTI-PORT VALVE

(71) Applicant: SHIMADZU CORPORATION, Kyoto (JP)

(72) Inventors: Ko NAKAHARA, Kyoto (JP); Ryota KANAMARU, Kyoto (JP)

(73) Assignee: SHIMADZU CORPORATION, Kyoto (JP)

(21) Appl. No.: 19/578,554

(22) Filed: Mar. 25, 2026

(30) Foreign Application Priority Data
Apr. 11, 2025 (JP) 2025-065445

(51) Int. Cl. F16K 11/074; G01N 30/02; G01N 30/20

(52) U.S. Cl. CPC F16K 11/0743; G01N 30/20; G01N 2030/027; G01N 2030/201

(57) ABSTRACT

On a rotor contact surface which is a contact surface of a stator with a rotor, odd-numbered outer openings which are openings communicating with respective outer ports are arranged evenly in a circumferential direction, and a center opening which is an opening communicating with a center port is provided at a center position among the odd-numbered outer openings. On a stator contact surface which is a contact surface of the rotor with the stator, a first groove extending in a radial direction of an opening-passing circle which is a circle passing through all of the odd-numbered outer openings, for allowing fluid communication between one outer opening among the odd-numbered outer openings and the center opening, and one or more second grooves extending along the opening-passing circle, for allowing fluid communication between all outer openings other than the one outer opening in fluid communication with the center opening via the first groove and another outer opening positioned adjacently, are provided.

### TECHNICAL FIELD

The present invention relates to a multi-port valve used for switching flow path connections in an analytical instrument such as a liquid chromatograph.

### BACKGROUND ART

An auto-sampler of a liquid chromatograph is generally configured to inject a sample into a mobile phase flowing toward an analysis column by incorporating a sample loop holding the sample into an analysis flow path through which the mobile phase flows. A multi-port valve such as a 6-port 2-position valve is used to switch whether to incorporate the sample loop into the analysis flow path or not (Patent Document 1).

### PRIOR ART DOCUMENTS

### Patent Documents

[Patent Document 1] International Publication No. WO 2019/211930

### SUMMARY OF THE INVENTION

### Problems to be Solved by the Invention

A multi-port valve used in an auto-sampler is configured to include a plurality of connection ports for connecting pipes, and to change a combination of the connection ports in fluid communication with each other by rotating a rotor provided with grooves for allowing fluid communication between the plurality of connection ports. In the multi-port valve, since the rotor is pressed against a stator with a strong force in order to maintain sealing performance between the rotor and the stator, a strong load is applied to sliding surfaces of the rotor and the stator every time the rotor rotates, causing wear of the rotor and/or the stator. Therefore, in order to extend the life of the rotor and the stator, it is necessary to reduce the load applied to the sliding surfaces of the rotor and the stator.

The present invention has been made in view of the above problems, and an object of the present invention is to provide a multi-port valve having a structure capable of reducing a load applied to sliding surfaces of a rotor and a stator.

### Means for Solving the Problems

As a multi-port valve for an auto-sampler, a 6-port 2-position valve is often used. In the 6-port 2-position valve, six connection ports for connecting pipes are arranged on an outer surface of a stator so as to form vertices of a regular hexagon, and six openings communicating with the connection ports are provided on the same circumference on a contact surface of the stator with a rotor. On a contact surface of the rotor with the stator, three arc-shaped grooves are provided for bringing two mutually adjacent openings among the six openings provided in the stator into fluid communication with each other, respectively.

On the sliding surfaces of the rotor and the stator of the multi-port valve, since an outer peripheral portion of the rotor has the longest driving distance, a sliding portion between the outer peripheral portion of the rotor and the stator is most likely to wear. As a method of suppressing wear of the sliding portion between the outer peripheral portion of the rotor and the stator, it is conceivable to reduce the outer diameter of the rotor. However, in the 6-port 2-position valve having the above-described structure, the outer diameter of the rotor needs to have a size corresponding to the size of a circle passing through the six openings provided on the contact surface of the stator with the rotor, and there is a limit to reducing the outer diameter of the rotor.

To address the above problem, a first form of a multi-port valve according to the present invention is a multi-port valve comprising a stator having a plurality of connection ports for connecting pipes, and a rotor provided so as to rotate in a state of being in contact with the stator, and configured such that a combination of two of the connection ports in fluid communication with each other is changed by changing a rotational position of the rotor, wherein
on an outer surface of the stator, as the connection ports, three or more odd-numbered outer ports arranged evenly in a circumferential direction, and one center port provided at a center position among the odd-numbered outer ports are provided,
on a rotor contact surface which is a contact surface of the stator with the rotor, odd-numbered outer openings which are openings communicating with the respective outer ports are arranged evenly in a circumferential direction, and a center opening which is an opening communicating with the center port is provided at a center position among the odd-numbered outer openings, and
on a stator contact surface which is a contact surface of the rotor with the stator,
a first groove extending in a radial direction of an opening-passing circle which is a circle passing through all of the odd-numbered outer openings, for allowing fluid communication between one outer opening among the odd-numbered outer openings and the center opening, and
one or more second grooves extending along the opening-passing circle, for allowing fluid communication between all outer openings other than the one outer opening in fluid communication with the center opening via the first groove and another outer opening positioned adjacently, are provided.

Further, in order to reduce the load on the sliding surface between the rotor and the stator, it is necessary to minimize the surface pressure applied to the sliding surface as much as possible, but this is also related to the area of the grooves provided in the rotor. The relationship between the necessary minimum surface pressure on the sliding surface between the rotor and the stator and the maximum liquid delivery pressure is expressed by the following equation:

Necessary minimum surface pressure>Maximum liquid delivery pressure+Axial force generated at the rotor groove at the time of maximum liquid delivery pressure

When liquid delivery pressure is generated, an axial force (liquid delivery pressure x area of groove) is generated at the groove of the rotor. If the liquid delivery pressure is the same, the larger the area of the groove, the larger the axial force generated at the groove of the rotor, and thus the surface pressure required for the sliding surface between the rotor and the stator increases. Conversely, the smaller the area of the groove of the rotor, the smaller the surface pressure required for the sliding surface between the rotor and the stator can be made, and the load on the sliding surface between the rotor and the stator can be reduced. One method of reducing the area of the groove of the rotor is to reduce the width of the groove.

By the way, when connecting a connection port provided on an outer peripheral portion of the outer surface to the sliding surface by a linear flow path, each opening which is an end portion of the flow path has an elliptical shape having a major axis in the radial direction of the circle. When the width of the groove of the rotor is smaller than the length of the major axis of these openings, the edge of the opening of the stator comes into contact with the rotor during rotation of the rotor, so that wear of the sliding surface between the stator and the rotor is promoted. Therefore, the width of the groove of the rotor needs to be larger than the length of the major axis of the opening of the stator. Therefore, in the conventional stator structure, there is a limit to reducing the width of the groove of the rotor.

To address the above problem, a second form of a multi-port valve according to the present invention is a multi-port valve comprising a stator having a plurality of connection ports for connecting pipes, and a rotor provided so as to rotate in a state of being in contact with the stator, and configured such that a combination of the connection ports in fluid communication with each other is changed by changing a rotational position of the rotor, wherein
on an outer surface of the stator, a plurality of outer ports arranged in a circumferential direction are provided as the connection ports, and
on a rotor contact surface which is a contact surface of the stator with the rotor, a plurality of outer openings which are elliptical openings linearly communicating with the respective outer ports are arranged in a circumferential direction, and a major axis of each of the outer openings is along a tangential direction of an opening-passing circle which is a circle passing through all of the outer openings.

### Effects of the Invention

According to the first form of the multi-port valve according to the present invention, on the rotor contact surface of the stator, the odd-numbered outer openings which are openings communicating with the respective outer ports are arranged evenly in the circumferential direction, and the center opening which is the opening communicating with the center port is provided at the center position among the odd-numbered outer openings, and on the stator contact surface of the rotor, the first groove extending in the radial direction of the opening-passing circle which is the circle passing through all of the odd-numbered outer openings, for allowing fluid communication between one outer opening among the odd-numbered outer openings and the center opening, and the one or more second grooves extending along the opening-passing circle, for allowing fluid communication between all outer openings other than the one outer opening in fluid communication with the center opening via the first groove and another outer opening positioned adjacently, are provided. Therefore, the number of openings (outer openings) arranged on the same circumference on the rotor contact surface of the stator is smaller than the number of connection ports provided on the outer surface of the stator, and the outer diameter of the rotor can be made smaller than that of a multi-port valve having a structure in which the same number of openings as the connection ports provided on the outer surface of the stator are provided on the same circumference on the rotor contact surface of the stator. Thereby, the moving distance of the outer peripheral portion of the rotor when rotating the rotor can be reduced, and the load applied to the sliding surface between the rotor and the stator can be reduced.

Further, considering interference such as the outer diameter of pipes connected to the connection ports and the size of pipe connection members for connecting the pipes to the connection ports, the size of the stator inevitably increases in proportion to the number of connection ports provided on the outer peripheral portion of the stator. In contrast, in the first multi-port valve according to the present invention, since one of the connection ports is the center port and the remaining ports are the outer ports provided on the outer peripheral portion of the stator, the stator can be made smaller compared to a multi-port valve in which all connection ports are provided on the outer peripheral portion. Since the stator is miniaturized, miniaturization of the rotor is facilitated, the volume of the flow path in the multi-port valve can be reduced, and the dead volume can be reduced.

According to the second form of the multi-port valve according to the present invention, on the rotor contact surface of the stator, the plurality of outer openings which are elliptical openings linearly communicating with the respective outer ports are arranged in the circumferential direction, and the major axis of each of the outer openings is along the tangential direction of the opening-passing circle which is the circle passing through all of the outer openings. Therefore, compared to a conventional structure in which the outer opening has a longitudinal direction in the radial direction of the opening-passing circle, the width of the groove of the rotor provided along the opening-passing circle can be narrowed. Thereby, the area of the groove of the rotor can be reduced, and the load applied to the sliding surface between the rotor and the stator can be reduced. Further, since the area of the groove of the rotor can be reduced, the dead volume in the multi-port valve can be reduced.

### BRIEF DESCRIPTION OF DRAWINGS

FIG. 1 is a cross-sectional configuration diagram showing one embodiment of a multi-port valve.

FIG. 2 is a diagram showing a rotor contact surface of a stator in the same embodiment.

FIG. 3 is a diagram showing a stator contact surface of a rotor in the same embodiment.

FIG. 4 is a diagram showing a rotor contact surface of a stator in a case where outer connection ports are provided along a radial direction of a rotor on an outer surface of the stator (Comparative Example).

FIG. 5 is a diagram showing a stator contact surface of a rotor in the same comparative example.

### MODE FOR CARRYING OUT THE INVENTION

Hereinafter, an embodiment of a multi-port valve according to the present invention will be described with reference to the drawings.

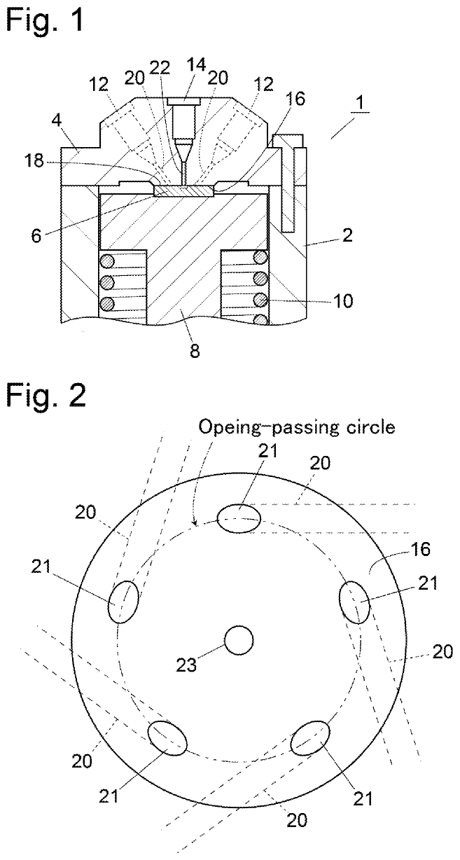

As shown in FIG. 1, the multi-port valve 1 includes a valve body 2, a stator 4, a rotor 6, a rotor shaft 8, and a rotor spring 10.

The valve body 2 is a cylindrical member having one end (upper end in the figure) open. The stator 4 is attached to one end of the stator 4 with bolts so as to close the opening of the one end of the valve body 2. The rotor 6, the rotor shaft 8, and the rotor spring 10 are accommodated inside the valve body 2.

The rotor 6 is held on a tip surface (upper end surface in the figure) of the rotor shaft 8. The rotor shaft 8 is axially rotated by a motor (not shown). The rotor shaft 8 is biased toward the stator 4 by the rotor spring 10, whereby the rotor 6 is pressed against the stator 4. The rotor 6 rotates while sliding on the stator 4 as the rotor shaft 8 rotates.

The stator 4 includes five outer ports 12 arranged evenly in a circumferential direction on an outer peripheral portion of an outer surface, and includes a center port 14 at a center portion among the five outer ports 12 on the outer surface. The outer ports 12 and the center port 14 are connection ports for connecting pipes, respectively. Inside the stator 4, outer flow paths 20 extending linearly from the respective outer ports 12 to a contact surface 16 of the stator 4 with the rotor 6 (hereinafter, rotor contact surface 16), and a center flow path 22 extending linearly from the center port 14 to the rotor contact surface 16 are provided. A central axis direction of the outer flow path 20 is inclined with respect to the rotor contact surface 16, and a central axis direction of the center flow path 22 is perpendicular to the rotor contact surface 16. The outer flow paths 20 and the center flow path 22 have circular cross-sectional shapes in a direction perpendicular to the central axis, and both have the same inner diameter.

As shown in FIG. 2, on the rotor contact surface 16 of the stator 4, five outer openings 21 which are end portions of the respective outer flow paths 20, and a center opening 23 which is an end portion of the center flow path 22 are provided. The five outer openings 21 are arranged evenly in the circumferential direction, and the center opening 23 is provided at the center of a circle passing through the centers of all the outer openings 21 (hereinafter referred to as an opening-passing circle).

The outer opening 21, which is the end portion of the outer flow path 20, has an elliptical shape because the outer flow path 20 is inclined with respect to the rotor contact surface 16. The outer flow path 20 is provided so as to extend in a direction along a tangential direction of the opening-passing circle so that a major axis direction of the outer opening 21 is along the tangential direction of the opening-passing circle. Extending in the direction along the tangential direction of the opening-passing circle means that an extending direction component of the outer flow path 20 parallel to the rotor contact surface 16 is substantially parallel to the tangent of the opening-passing circle.

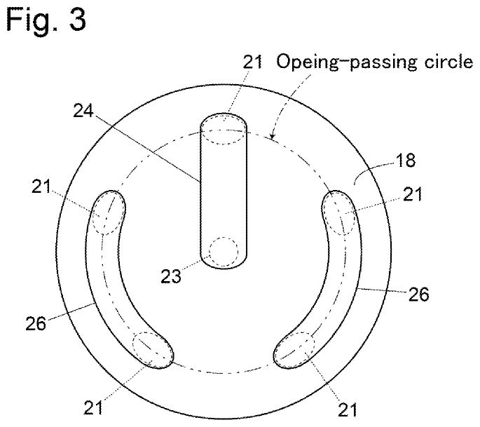

As shown in FIG. 3, on a contact surface 18 of the rotor 6 with the stator 4 (hereinafter, stator contact surface 18), one first groove 24 and two second grooves 26 for allowing fluid communication between the openings 21 and 23 provided on the rotor contact surface 16 of the stator 4 are provided. The first groove 24 is a groove for allowing fluid communication between one outer opening 21 and the center opening 23, and extends in a radial direction of the opening-passing circle. Each of the two second grooves 26 is a groove for allowing fluid communication between two outer openings 21, and has an arc shape along the opening-passing circle with a central angle of about 72 degrees. By aligning the position of the rotor 6 so that the center opening 23 and one outer opening 21 are in fluid communication via the first groove 24, the remaining four outer openings 21 not in fluid communication with the center opening 23 are in fluid communication with another adjacent outer opening 21 on the opening-passing circle via the second grooves 26. Then, by rotating the rotor 6 by 72 degrees from that state, the outer opening 21 in fluid communication with the center opening 23 is switched, and at the same time, the combination of the outer openings 21 in fluid communication with each other is switched.

With the above configuration, the multi-port valve 1 can be used as a 6-port 2-position valve. The present invention is not limited to one having six connection ports, and can be applied to a multi-port valve having n connection ports, where n is an even number of 4 or more. That is, one of the n connection ports can be used as a center port, and the remaining n−1 connection ports can be used as outer ports and arranged evenly in the circumferential direction around the center port. In that case, the rotor 6 is provided with one first groove 24 and (n−2 )/2 arc-shaped second grooves 26. For example, when eight connection ports are provided in the stator 4, seven outer ports 12 are provided on the outer peripheral portion of the stator 4, seven outer openings 21 are provided on the rotor contact surface 16 of the stator 4, and three second grooves 26 are provided on the stator contact surface 18 of the rotor 6.

In a general 2-position valve having n connection ports, openings leading to respective n connection ports are arranged evenly in the circumferential direction on the rotor contact surface of the stator. Assuming that an interval between the openings arranged in the circumferential direction is L, L can be expressed by the following equation (1) using a diameter dₙ of an opening-passing circle passing through the centers of the n openings.

L=πdₙ×1/n (1)

On the other hand, as in this embodiment, when one connection port among n connection ports is used as a center port and n−1 connection ports are used as outer ports, and n−1 openings leading to the outer ports are arranged evenly in the circumferential direction on the rotor contact surface of the stator, the interval L between the openings arranged in the circumferential direction can be expressed by the following equation (2) using a diameter dₙ₋₁ of an opening-passing circle passing through the centers of the n−1 openings.

L=πdₙ₋₁×1/(n−1) (2)

Rearranging the above equations (1) and (2), the following equation (3) is obtained.

dₙ₋₁=dₙ×(n−1)/n (3)

From the above equation (3), even if the distance between openings arranged evenly in the circumferential direction on the rotor contact surface of the stator is the same, if the number of openings decreases, the diameter of the opening-passing circle passing through those openings can be reduced accordingly. If the diameter of the opening-passing circle can be reduced, the outer diameter of the rotor can also be reduced accordingly, and wear of the sliding surface between the rotor and the stator can be reduced.

Further, by arranging n−1 connection ports among n connection ports provided on the outer surface of the stator 4 as outer ports 12 on the outer peripheral portion, and arranging the remaining one connection port as the center port 14 at the center portion of the outer ports 12, the stator 4 itself can be miniaturized. By miniaturizing the stator 4 itself, the length of the flow paths provided inside the stator 4 can be shortened to reduce the dead volume, and further, miniaturization of the rotor 6 is facilitated, and the lengths of the grooves 24 and 26 provided in the rotor 6 can be shortened to reduce the dead volume.

Further, as shown in FIG. 3, the width dimension of the second groove 26 provided on the stator contact surface 18 of the rotor 6 is slightly larger than the length of the minor axis of the outer opening 21 and smaller than the length of the major axis. Since the width dimension of the second groove 26 is slightly larger than the length of the minor axis of the outer opening 21, the stator contact surface 18 of the rotor 6 is suppressed from being scraped off by the edge of the outer opening 21 during rotation of the rotor 6.

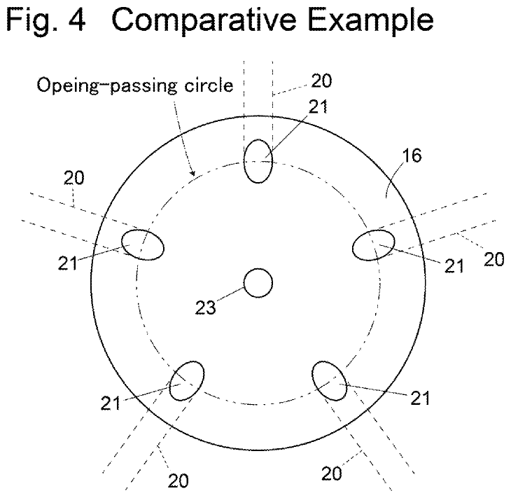

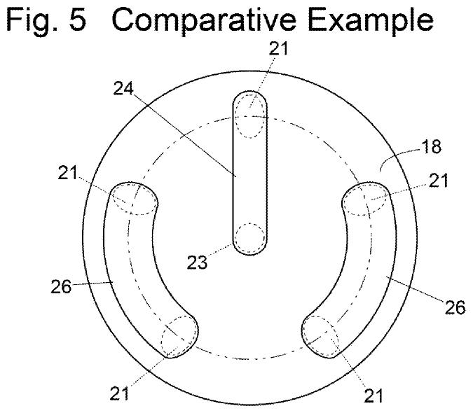

FIG. 4 is a diagram showing, as a comparative example, an example of a state of the rotor contact surface 16 of the stator 4 when the outer flow path 20 is provided along the radial direction of the opening-passing circle, and FIG. 5 is a diagram showing an example of the flow paths 24 and 26 provided on the stator contact surface 18 of the rotor 6 corresponding to the rotor contact surface 16 shown in FIG. 4.

As shown in FIG. 4, when the outer flow path 20 is provided along the radial direction of the opening-passing circle, that is, when the component of the outer flow path 20 parallel to the rotor contact surface 16 is parallel to the radial direction of the opening-passing circle, the major axis of the outer opening 21 comes to be along the radial direction of the opening-passing circle, and the dimension of the outer opening 21 in the radial direction of the opening-passing circle becomes larger than the inner diameter of the outer flow path 20. Therefore, in order to suppress the rotor 6 from being scraped off by the edge of the outer opening 21, as shown in FIG. 5, it is necessary to make the width dimension of the second groove 26 of the stator contact surface 18 of the rotor 6 larger than the length of the major axis of the outer opening 21.

In contrast, as shown in FIG. 3, in this embodiment, since the outer opening 21 is formed such that the major axis is along the tangential direction of the opening-passing circle, the width dimension of the second groove 26 of the stator contact surface 18 of the rotor 6 may be made larger than the minor axis of the outer opening 21, and the width dimension can be made smaller than that of the comparative example of FIG. 5. As a result, the area of the groove provided in the rotor 6 can be made smaller than that of the comparative example.

Note that the embodiment described above is merely an example of an embodiment of the multi-port valve according to the present invention. Embodiments of the multi-port valve according to the present invention are as follows.

A first embodiment of the multi-port valve according to the present invention is a multi-port valve comprising a stator having a plurality of connection ports for connecting pipes, and a rotor provided so as to rotate in a state of being in contact with the stator, and configured such that a combination of two of the connection ports in fluid communication with each other is changed by changing a rotational position of the rotor, wherein
on an outer surface of the stator, as the connection ports, three or more odd-numbered outer ports arranged evenly in a circumferential direction, and one center port provided at a center position among the odd-numbered outer ports are provided,
on a rotor contact surface which is a contact surface of the stator with the rotor, odd-numbered outer openings which are openings communicating with the respective outer ports are arranged evenly in a circumferential direction, and a center opening which is an opening communicating with the center port is provided at a center position among the odd-numbered outer openings, and
on a stator contact surface which is a contact surface of the rotor with the stator,
a first groove extending in a radial direction of an opening-passing circle which is a circle passing through all of the odd-numbered outer openings, for allowing fluid communication between one outer opening among the odd-numbered outer openings and the center opening, and
one or more second grooves extending along the opening-passing circle, for allowing fluid communication between all outer openings other than the one outer opening in fluid communication with the center opening via the first groove and another outer opening positioned adjacently, are provided.

In a first aspect of the first embodiment, five outer ports are provided in the stator, and on the stator contact surface of the rotor, the two second grooves are provided in the shape of an arc along the opening-passing circle having a central angle of 72 degrees, respectively. According to such an aspect, the multi-port valve can function as a 6-port 2-position valve generally used in a liquid chromatograph. Since the multi-port valve of this first aspect has a smaller number of connection ports provided on the outer peripheral portion of the stator than a conventional 6-port 2-position valve, miniaturization of the stator and the rotor is possible. Thereby, the load applied to the sliding surface between the rotor and the stator can be reduced, and further, the dead volume in the multi-port valve can be reduced.

In a second aspect of the first embodiment, each of the odd-numbered outer openings has an elliptical shape having a major axis direction along the tangential direction of the opening-passing circle. When providing a flow path linearly leading from a connection port (outer port) provided on the outer peripheral portion of the stator to the rotor contact surface, in a conventional structure, an opening (outer opening) having a major axis along the radial direction of the opening-passing circle is formed on the rotor contact surface. In such a structure, in order to prevent the rotor from being scraped off by the edge of the opening during rotation of the rotor, it is necessary to make the width of the rotor groove larger than the major axis of the opening, and the area of the rotor groove tends to be large. In contrast, in this second aspect, since the major axis direction of the outer opening is along the tangential direction of the opening-passing circle, even when preventing the rotor from being scraped off by the edge of the opening during rotation of the rotor, the width of the second groove of the rotor along the opening-passing circle can be made smaller than that of the conventional structure. Thereby, the area of the rotor groove can be reduced, the load applied to the sliding surface between the rotor and the stator can be reduced, and the dead volume in the multi-port valve can be reduced. This second aspect can be combined with the first aspect.

As a specific structure of the second aspect, an example can be cited in which the stator includes a flow path extending linearly from the outer port toward the rotor contact surface in a direction along the tangential direction of the opening-passing circle, and the outer opening is located at an end portion of the outer flow path on the rotor contact surface side.

In the second aspect, the width dimension of the second groove of the rotor may be larger than the length of the minor axis of the outer opening of the rotor contact surface of the stator and smaller than the length of the major axis. Thereby, while suppressing the width of the second groove of the rotor to a width shorter than the major axis of the outer opening to reduce the area of the second groove, it is possible to suppress the rotor from being scraped off by the edge of the outer opening of the stator.

A second embodiment of the multi-port valve according to the present invention is a multi-port valve comprising a stator having a plurality of connection ports for connecting pipes, and a rotor provided so as to rotate in a state of being in contact with the stator, and configured such that a combination of the connection ports in fluid communication with each other is changed by changing a rotational position of the rotor, wherein
on an outer surface of the stator, a plurality of outer ports arranged in a circumferential direction are provided as the connection ports, and
on a rotor contact surface which is a contact surface of the stator with the rotor, a plurality of outer openings which are elliptical openings linearly communicating with the respective outer ports are arranged in a circumferential direction, and a major axis of each of the outer openings is along a tangential direction of an opening-passing circle which is a circle passing through all of the outer openings.

As a first aspect of the second embodiment, an aspect can be cited in which the stator includes an outer flow path extending linearly from the outer port toward the rotor contact surface in a direction along the tangential direction of the opening-passing circle, and the outer opening is located at an end portion of the outer flow path on the rotor contact surface side.

As a second aspect of the second embodiment, an aspect can be cited in which on a stator contact surface which is a contact surface of the rotor with the stator, a groove for extending along the opening-passing circle and allowing fluid communication between the plurality of outer openings is provided, and a width dimension of the groove is larger than the length of the minor axis of the outer opening and smaller than the length of the major axis. According to this second aspect, while suppressing the width of the rotor groove to a width shorter than the major axis of the outer opening to reduce the area of the second groove, it is possible to suppress the rotor from being scraped off by the edge of the outer opening of the stator.

### DESCRIPTION OF REFERENCE SIGNS

1 Multi-port valve
2 Valve body
4 Stator
6 Rotor
8 Rotor shaft
10 Rotor spring
12 Outer port
14 Center port
16 Rotor contact surface
18 Stator contact surface
20 Outer flow path
21 Outer opening
22 Center flow path
23 Center opening
24 First groove
26 Second groove

1. A multi-port valve comprising a stator having a plurality of connection ports for connecting pipes, and a rotor provided so as to rotate in a state of being in contact with the stator, and configured such that a combination of two of the connection ports in fluid communication with each other is changed by changing a rotational position of the rotor, wherein
on an outer surface of the stator, as the connection ports, three or more odd-numbered outer ports arranged evenly in a circumferential direction, and one center port provided at a center position among the odd-numbered outer ports are provided,
on a rotor contact surface which is a contact surface of the stator with the rotor, odd-numbered outer openings which are openings communicating with the respective outer ports are arranged evenly in a circumferential direction, and a center opening which is an opening communicating with the center port is provided at a center position among the odd-numbered outer openings, and
on a stator contact surface which is a contact surface of the rotor with the stator,
a first groove extending in a radial direction of an opening-passing circle which is a circle passing through all of the odd-numbered outer openings, for allowing fluid communication between one outer opening among the odd-numbered outer openings and the center opening, and
one or more second grooves extending along the opening-passing circle, for allowing fluid communication between all outer openings other than the one outer opening in fluid communication with the center opening via the first groove and another outer opening positioned adjacently, are provided.

2. The multi-port valve according to claim 1, wherein
five outer ports are provided in the stator, and
on the stator contact surface of the rotor, the two second grooves are provided in the shape of an arc along the opening-passing circle having a central angle of 72 degrees, respectively.

3. The multi-port valve according to claim 1, wherein each of the odd-numbered outer openings has an elliptical shape having a major axis direction along a tangential direction of the opening-passing circle.

4. The multi-port valve according to claim 3, wherein the stator includes a flow path extending linearly from the outer port toward the rotor contact surface in a direction along the tangential direction of the opening-passing circle, and the outer opening is located at an end portion of the outer flow path on the rotor contact surface side.

5. The multi-port valve according to claim 3, wherein a width dimension of the second groove of the rotor is larger than a length of a minor axis of the outer opening of the rotor contact surface of the stator and smaller than a length of a major axis.

6. A multi-port valve comprising a stator having a plurality of connection ports for connecting pipes, and a rotor provided so as to rotate in a state of being in contact with the stator, and configured such that a combination of the connection ports in fluid communication with each other is changed by changing a rotational position of the rotor, wherein
on an outer surface of the stator, a plurality of outer ports arranged in a circumferential direction are provided as the connection ports, and
on a rotor contact surface which is a contact surface of the stator with the rotor, a plurality of outer openings which are elliptical openings linearly communicating with the respective outer ports are arranged in a circumferential direction, and a major axis of each of the outer openings is along a tangential direction of an opening-passing circle which is a circle passing through all of the outer openings.

7. The multi-port valve according to claim 6, wherein the stator includes an outer flow path extending linearly from the outer port toward the rotor contact surface in a direction along the tangential direction of the opening-passing circle, and the outer opening is located at an end portion of the outer flow path on the rotor contact surface side.

8. The multi-port valve according to claim 6, wherein
on a stator contact surface which is a contact surface of the rotor with the stator, a groove for extending along the opening-passing circle and allowing fluid communication between the plurality of outer openings is provided, and
a width dimension of the groove is larger than a length of a minor axis of the outer opening and smaller than a length of a major axis.
